(19) United States
(12) Patent Application Publication
(10) Pub. No.: US 2012/0122394 A1
(43) Pub. Date: May 17, 2012

(54) SENSOR NODES WITH FREE-SPACE SIGNALING

(76) Inventors: Alexandre Bratkovski, Mountain View, CA (US); R. Stanley Williams, Portola Valley, CA (US)

(21) Appl. No.: 13/386,364

(22) PCT Filed: Jan. 29, 2010
(86) PCT No.: PCT/US10/22496

§ 371 Date: Jan. 20, 2012

(51) Int. Cl. H04B 7/24

(52) U.S. Cl. 455/39

(57) ABSTRACT

Apparatus and systems are provided for data signaling between a centralized transceiver and a plurality of sensor nodes. Each sensor node independently generates electrical power from one or more renewable sources. Each sensor node transmits data corresponding to sensed physical variables to the transceiver by free-space signaling. Large areas can be monitored by a vast array of such sensors without the need for wiring, optical fibers or other tangible interconnections.

### CROSS-REFERENCE TO RELATED APPLICATION

This application is related to co-pending application serial number PCT/US2010/022501, titled “Subordinate and Master Sensor Nodes”, naming Alexandre M. Bratkovski, Marco Fiorentino and Raymond G. Beausoleil as co-inventors, filed on the same date as the instant application, and which is hereby incorporated by reference.

### BACKGROUND

Large arrays of sensors are used in myriad endeavors such as oil field monitoring, seismic investigation, hydrology and others. In an illustrative scenario, many individual sensor units—upwards of a million or more—are distributed over an area of interest such as an oil or natural gas field. Various physical variables such as seismic waves, geomagnetic flux, sonar echoes and other parameters can be sensed by way of such an array.

However, known technology is dependent upon various wiring and cabling schemes in order to provide operating energy to and receive data from the numerous sensors. Considerable cost, labor and materials are required to install and maintain interconnecting wiring between sensors and a data acquisition hub. The present teachings address the foregoing concerns.

### BRIEF DESCRIPTION OF THE DRAWINGS

The present embodiments will now be described, by way of example, with reference to the accompanying drawings, in which:

FIG. 1 depicts a perspective diagrammatic view of a system according to one embodiment;

FIG. 2 depicts an elevation view of a system according to another embodiment;

FIG. 3 depicts a block diagram of a sensor device according to one embodiment;

FIG. 4 depicts a block diagram of a data acquisition system according to one embodiment;

FIG. 5 depicts a flow diagram of a method according to one embodiment.

### DETAILED DESCRIPTION

Introduction

Means and methods are provided for use with large arrays of discrete physical variable sensor nodes. Each sensor node is configured to independently generate electrical power from one or more renewable sources. Each sensor node is also configured to transmit data corresponding to the sensed variables to a centralized transceiver by way of free-space signaling. The centralized transceiver, or a portion thereof, can be supported within signaling range of the sensor array by a tower, a lighter-than-air craft, etc. Large areas can be monitored by a vast array of such sensor nodes without the need for wiring, optical fibers or other tangible interconnections.

In one embodiment, a system includes a plurality of sensor nodes configured to sense one OF more physical variables. Each sensor node is configured to transmit data corresponding to the one or more physical variables by way of free-space signaling. Each sensor node is additionally configured to generate electrical energy. The system also includes a data transceiver configured to receive data from the plurality of sensor nodes by way of the free-space signaling.

In another embodiment, an apparatus includes a transducer configured to derive electrical energy from a physical input. The apparatus also includes a sensor configured to provide signals corresponding to at least one sensed physical variable. Additionally, the apparatus includes a transceiver configured to transmit data corresponding to the signals. The transceiver is also configured to transmit the data by way of free-space signaling. The transceiver and the sensor respectively operate by way of electrical energy derived by the transducer.

First Illustrative System

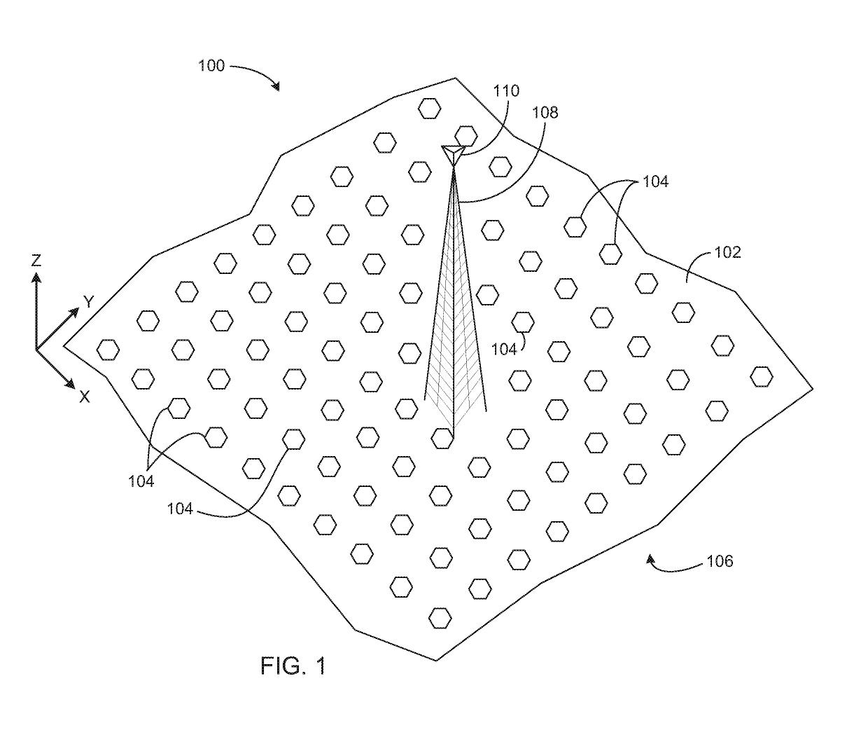

Reference is now made to FIG. 1, which depicts a perspective view of a system 100 according to the present teachings. The system 100 is illustrative and non-limiting with respect to the present teachings. Thus, other embodiments can be configured and/or used in accordance with the present teachings, including respectively varying characteristics and elements.

The system 100 operates within an environment including a ground surface area 102. For purposes of understanding, the surface area 102 is defined by X-and-Y dimensions and is assumed to be substantially flat (planar). However, the present teachings contemplate other surface areas having various topologies and features.

The system 100 also includes a plurality of individual sensor nodes (sensors) 104. Each of the individual sensors 104 is configured to derive its own operating power from one or more renewable sources by way of appropriate transducers. Additionally, each sensor 104 is configured to transmit data corresponding to one or more sensed physical variables by way of free-space signaling. Further elaboration of such sensors according to the present teachings is provided hereinafter. The plurality sensor nodes 104 are distributed over the surface area 102 such that an array or mesh 106 is defined.

The system 100 further includes a tower 108 located generally within the central of the ground surface area 102, The tower 108 extends away from the surface area 102 in a “Z” direction as indicated—that is, normal to the surface area 102, The tower 108 supports a signaling element 110. As depicted, the signaling element 110 is defined by a number of corner-cube reflectors configured to receive optical free-space signals from the sensor nodes 104. For non-limiting example, the signaling element 110 can be configured to receive infra-red light wave data signals from the sensors 104.

Other signaling elements 110 such as, for non-limiting example, antennae, phototransistors, photodiodes, etc., can be used in accordance with the free-space signaling schema of the system 100. The signaling element 110 is understood to be coupled in signal communication with a data acquisition apparatus such as a transceiver, computer, data storage, or other elements, Further description of an illustrative data acquisition system is provided hereinafter.

Typical normal operations of the system 100 are described in detail hereinafter. In general, and without limitation, the sensor nodes 104 operate in an autonomous and independent manner, generating electrical power from solar energy, wind power, thermoelectric effects or other means. The sensors 104 also sense one or more physical variables such as seismic waves, etc., and provide corresponding free-space data signal transmissions to the signaling element 110 atop the tower 108. Identifying (or location, etc.) information for each sensor 104 can also be provided in some or all of the free-space signaling transmissions. In this way, the array 106 of sensors 104 can monitor a vast area 102 without need for interconnecting electrical wiring, fiber optic signal cabling, or other similar resources.

Second Illustrative System

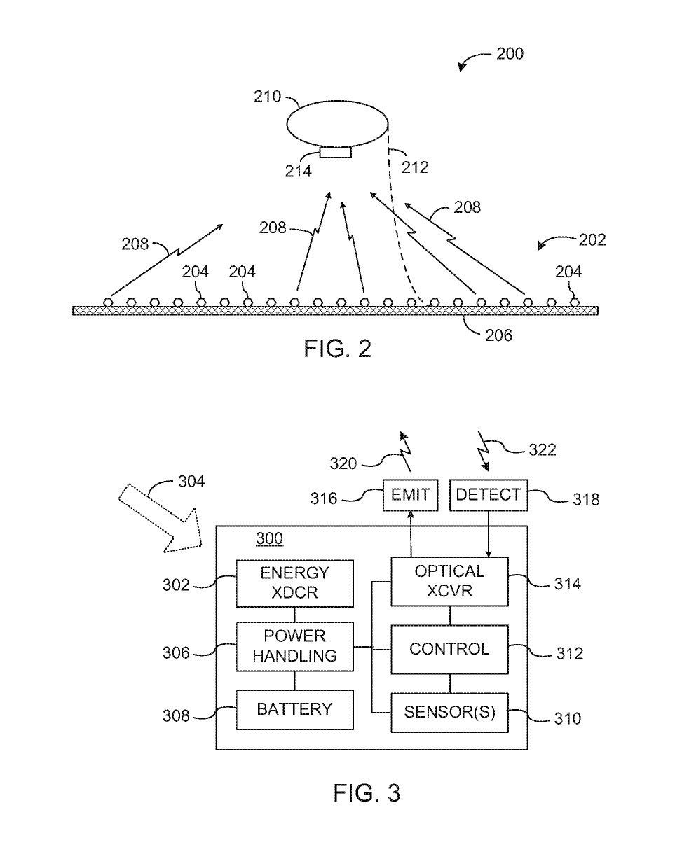

Attention is now directed to FIG. 2, which depicts an elevation view of a system 200 according to an embodiment of the present teachings. The system 200 is illustrative and non-limiting with respect to the present teachings. Thus, other systems can be configured and/or used in accordance with the present teachings.

The system 200 includes an array 202 of plural sensor nodes 204. The sensor nodes 204 are distributed over a supporting surface area 206. The sensors 204 are configured to derive electrical energy from one or more renewable sources. The sensors 204 are also configured to sense one or more physical variables and to transmit data corresponding to those sensed variable by way of free-space signals 208.

The system 200 also includes a lighter-than-air craft 210. The lighter-than-air craft 210 can be defined by a hydrogen- or helium-filled balloon or blimp, or some other suitable means. The lighter-than-air craft 210 is secured in place over the surface area 206 by one or more guy lines 212.

The system 200 includes a data transceiver (or acquisition device) 214 supported by the lighter-than-air craft 210. The data transceiver 214 is configured to transmit query (or interrogation) signals to the sensor nodes 204. The data transceiver 214 is further configured to receive free-space signals 208 from the sensors 204, Such signals 208 are suitably modulated to convey data from the sensors 204.

In this way, the data transceiver 214 can request and receive physical variable data from the sensor nodes 204. Additionally, the array 202 can be distributed over a relatively vast area 206 (i.e., acres, square kilometers, etc.) without interconnecting wires, cables, etc. Free-space signal 208 communication with very large numbers of sensors 204 is performed by virtue of the airborne operation of the data transceiver 214. In turn, the data transceiver 214 can be configured to record the received data, or relay the data as a stream or packets to another airborne or ground-based telemetry station (not shown).

First Illustrative Sensor

Attention is now directed to FIG. 3, which depicts block diagram of a sensor (or sensor node) 300 according to the present teachings. The sensor 300 is illustrative and non-limiting in nature. Other sensors can be defined, configured and used in accordance with the present teachings.

The sensor 300 includes an energy transducer 302. The transducer 302 is configured to generate, or derive, electrical energy directly from a physical stimulus input 304. The energy transducer 302 can be defined by one or more photovoltaic cells, wind-power generators, thermoelectric cells, thermopiles, etc. Other suitable energy transducers 302 can also be used. Accordingly, the physical stimulus input 304 can be sunlight, wind, thermal flux due to temperature differences, etc., respectively.

The sensor node 300 also includes power handling 306. Power handling 306 can be defined by or include any suitable circuitry or resources configured to receive electrical energy from the energy transducer 302 and to condition or regulate at least one parameter of that energy. For non-limiting example, the power handling 306 can be configured to provide a regulated direct-current (DC) voltage output in response to varying electrical energy potential received from the energy transducer 302.

As such, the power handling 306 can include digital or analog circuitry, a microprocessor or microcontroller, a state machine, etc. As depicted, the power handling 306 is configured to provide a regulated DC voltage output and to store electrical energy within a battery 308. In turn, the battery 308 can be defined by any suitable rechargeable storage cell or array such as a nickel-cadmium (NiCad) battery, a lithium ion (Li-ion) battery, etc. Power stored within the battery 308 can be drawn upon by the power handling 306 during times of insufficient physical input 304. For non-limiting example, energy can be drawn from the battery 308 and used during night-time operations within a solar powered embodiment of sensor 300.

The sensor 300 further includes one or more sensors 310. The sensor(s) 310 can be defined by any suitable sensor or sensors (detectors, or transducers) configured to sense corresponding physical variables and to provide calibrated signals. Non-limiting examples of such sensor(s) 310 include acoustic microphones, seismic sensors, thermometers, magnetic flux detectors, etc. Other suitable sensor types can also be used. The one or more sensors 310 receive operating-level electrical energy as needed from the power handling 306.

The sensor node 300 also includes a controller 312. The controller 312 is configured to control various normal operations of the sensor node 300. The controller 312 can be defined, at least in part, by a microprocessor, microcontroller, state machine, electronic circuitry, etc. The controller 312 can include or be defined by other resources, as well. The controller 312 receives operating power from the power handling 306.

The controller 312 is configured to receive signals from he sensors 310 and format those signals as needed into digital data for transmission away from the sensor node 300. The controller 312 can also include storage media so that digital data representing the sensed physical variables can be stored for later retrieval and transmission away from the sensor 300.

The sensor 300 further includes an optical transceiver 314. The transceiver 314 is configured to bidirectionally communicate data between the controller 312 and an entity or entities (e.g., data transceiver 214, etc.) external to the sensor node 300 by way of free-space optical signaling 320 and 322. Toward that end, the transceiver 314 includes an optical signal emitter 316 and an optical signal detector 318. The emitter 316 can be defined by one or more infra-red, visible or ultra-violet light-emitting diodes (LEDs), a laser, or other controllable light source. The detector 316 can be defined by one or more phototransistors, cadmium-sulfide cells, etc. Other suitable emitters 316 or detectors 318 can also be used.

In another embodiment (not shown), the optical transceiver 314 is omitted and replaced by a radio transceiver device configured to communicate data by way of radio signals. Other free-space signaling devices or schemes can also be used.

Normal, illustrative operation of the sensor node 300 is as follows: Physical stimulus 304 (e.g., solar energy, etc.) drives the energy transducer 302 to produce electrical energy. This electrical energy is coupled to power handling 306, which derives a regulated DC output voltage and stores some of the electrical energy within battery (or batteries) 308.

Meanwhile, the sensor(s) 310 sense one or more physical variables such as sonar echoes, etc., and provide corresponding signals to the controller 312. The controller 312 formats the signal or signals are respective digital data and provides that data to the optical transceiver 314. In turn, the optical transceiver 314 controls operation of the emitter 316 such that modulated free-space optical signals 320 corresponding to the digital data are transmitted from sensor 300. Such transmissions can also include an identifier for the sensor 300.

In another illustrative operating scenario, signals from the sensor(s) 310 are stored as digital data by the controller 312. A free-space interrogation signal 322 is then received by way of the detector 318 and optical transceiver 314. The controller 312 responds to this interrogation (or query) by retrieving stored digital data from media (memory) and transmitting that data by way of the optical transceiver 314.

First Illustrative Data Acquisition System

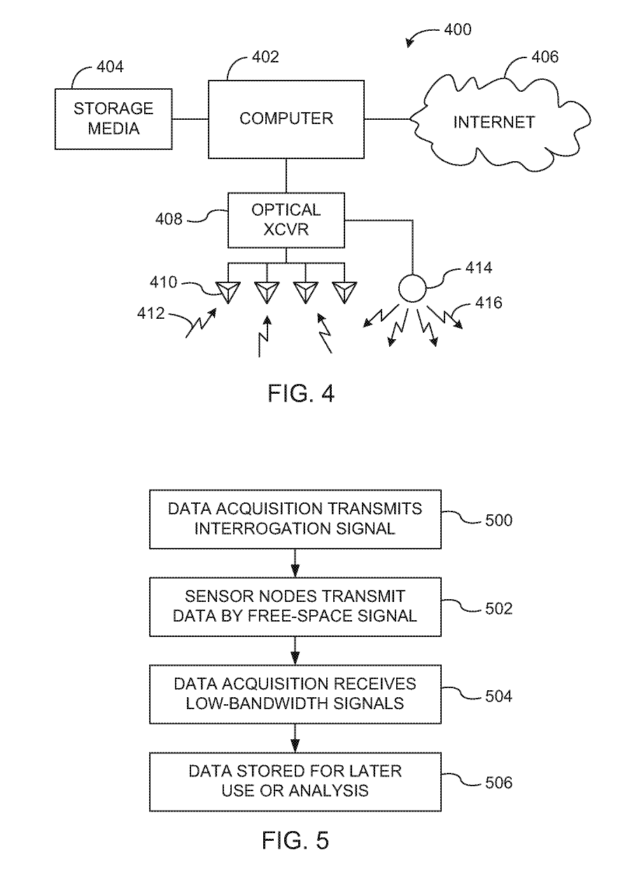

Attention is now directed to FIG. 4, which depicts block diagram of a data acquisition system (system) 400 according to the present teachings. The system 400 is illustrative and non-limiting in nature. Other systems can be defined, configured and used in accordance with the present teachings.

The system 400 includes a computer 402. The computer 402 is configured to receive data corresponding to one or more sensed physical variables as provided by numerous sensor nodes (e.g., sensor 300). The computer 402 is also configured to store the physical variable data within storage media 404. The storage media 404 can be any suitable computer-accessible storage media such as, for non-limiting example, optical storage, magnetic storage, non-volatile memory, random-access memory (RAM), etc. Other suitable forms of storage can also be used.

The computer 402 can be defined by any suitable computer system including one or more processors configured to operate in accordance with executable program code (i.e., software). The computer 402 can be used to analyze the received data, display the data in various numerical or graphical formats, etc. One having ordinary skill in the computing arts can appreciate that the computer 402 and program code can be various defined, and further elaboration is not needed for an understanding of the present teachings.

The computer 402 is also coupled to communicate data to other entities (computers, etc.) by way of the Internet 406. In another embodiment, the Internet 406 is replaced by, or provides access to, another local or wide-area network. In any case, the computer 402 is or can be configured to bidirectionally communicate with other entities by way of network connection, wireless means, etc.

The system 400 also includes an optical transceiver 408. The optical transceiver 408 is configured to perform data communications between the computer 402 and sensor nodes (e.g., 300, etc.) external to the system 400. The optical transceiver 408 is thus configured to reformat received signals as data readable by the computer 402. The optical transceiver 408 is also configured to reformat outgoing data or commands are signals for transmission.

The system 400 includes one or more corner-cube reflectors 410 coupled to the optical transceiver 408 disposed so as to receive incoming free-space signals 412. The system 400 also includes at least one optical emitter 414 configured to provide free-space signals 416 under the control of the optical transceiver 408. Free-space signals 412 and 416 can be defined by infra-red, visual or ultra-violet light wave signals. In an alternative embodiment, the optical transceiver 408 is replaced or supplemented by a radio frequency transceiver with appropriate antennae.

The system 400 can be supported, in whole or in part, by a tower (e.g., tower 108), a lighter-than-air craft (e.g., craft 210), or other means. In this way, the system 400 can be disposed within free-space signaling range of an array sensor nodes distributed over a relatively large area.

It is noted that the present teachings contemplate the use of various free-space signaling schemas and formats. These schemas include visual or non-visual light wave signaling, as well as radio frequency (RF) signals. It is also contemplated that relatively low-bandwidth signals can be used that is, signals having relatively low baud rates. This can be the case because the data quantities to be received over time from the sensor nodes are typically (but not necessarily) relatively small—and, optionally intermittent—as compared to a modern video signal or other high-bandwidth transmission. As such, data integrity can be better assured without many of the problems attributable to high-frequency noise, signal degradation along a propagation pathway, etc.

First Illustrative Method

FIG. 5 is a flow diagram depicting a method according to one embodiment of the present teachings. The method of FIG. 5 includes particular operations and order of execution. However, other methods including other operations, omitting one or more of the depicted operations, and/or proceeding in other orders of execution can also be used according to the present teachings. Thus, the method of FIG. 5 is illustrative and non-limiting in nature. Illustrative reference is also made to FIGS. 3 and 4 in the interest of understanding the method of FIG. 5.

At 500, a data acquisition system transmits an interrogation signal. For purposes of non-limiting illustration, it is assumed that a system 400 transmits an interrogation command by free-space signaling 416.

At 502, individual sensor nodes transmit data by free-space signaling. For purposes of the on-going illustration, sensor nodes 300 are assumed to respond to the interrogation of 500 above and transmit data corresponding to sensed physical variables. Data transmission occurs by way of free-space optical signals 412.

At 504, the data acquisition system receives low-bandwidth signals from the numerous sensor nodes. For purposes of the on-going illustration, the free-space signals 412 are received by the system 400 and provided to the computer 402 by way of the optical transceiver 408.

At 506, the data is stored for later analysis or other use. For purposes of the on-going illustration, it is assumed that the data, representing physical variables sensed by the sensor nodes 300, is stored within storage media 404 by way of the computer 402.

In accordance with the present teachings, and without limitation, sensor nodes are defined and configured to sense or more physical variables. Such physical variables are of interest in some field deployment scenario. The sensor nodes are also configured to communicate by way of free-space signals such as optical, radio, etc. The sensor nodes are further configured to derive their own operating power by way of photovoltaic, wind generation, or other renewable resource means. In this way, each sensor node is configured to operate in an independent, self-powered manner and to function as an element within a large-scale array without need for hardwired connection to an electrical or signal communications network.

Additionally, data acquisition systems of the present teachings can be supported in whole or in part at a generally elevated perspective point so as to remain within free-space signal communications range of numerous sensor nodes. Such data acquisition systems can be configured to query the sensor nodes, receive the corresponding data, store that data within appropriate media and analyze or display the data by way of appropriate software. Data acquisition systems can be further configured to communicate data with external entities by way of network connection, wireless signals, etc.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. A system, comprising:
A plurality of sensor nodes configured to sense one or more physical variables, each sensor node configured to transmit data corresponding to the one or more physical variables by way of free-space signaling, each sensor node configured to produce electrical energy; and
A data transceiver configured to receive data from the plurality of sensor nodes by way of the free-space signaling.

2. The system according to claim 1, the plurality of sensor nodes distributed within free-space signaling range of the data transceiver.

3. The system according to claim 1, at least one of the sensor nodes configured to produce electrical energy by way of a photovoltaic transducer, a thermoelectric transducer, or a wind-power transducer.

4. The system according to claim 1, the data transceiver supported by way of a tower, or a lighter-than-aft craft.

5. The system according to claim 1, the data transceiver further configured to send an interrogation signal to the plurality of sensor nodes by way of the free-space signaling.

6. The system according to claim 1, the data transceiver including at least one corner-cube reflector.

7. The system according to claim 1, the plurality of sensor nodes distributed as an array over a predetermined area.

8. The system according to claim 1, the data transceiver coupled to computer-accessible storage media configured to store data corresponding to the one or more physical variables.

9. The system according to claim 1, the data transceiver coupled to communicate data corresponding to the one or more physical variables by way of a network.

10. The system according to claim 1, each sensor node configured to operate without tangible coupling to the other sensor nodes.

11. An apparatus, comprising:
a transducer configured to derive electrical energy from a physical input;
a sensor configured to provide signals corresponding to at least one sensed physical variable; and
a transceiver configured to transmit data corresponding to the signals, the transceiver configured to transmit the data by way of free-space signaling, the transceiver and the sensor respectively operating by way of electrical energy derived by the transducer.

12. The apparatus according to claim 11 further comprising a battery configured to store electrical energy derived by the transducer.

13. The apparatus according to claim 11, the free-space signaling including at least optical signals, or radio signals.

14. The apparatus according to claim 11, the transducer defined by at least a photovoltaic transducer, a wind-power transducer, or a thermoelectric transducer.

15. The apparatus according to claim 11, the transceiver further configured to transmit the data in response to a free-space interrogation signal.
